(19) United States
(12) Patent Application Publication
(10) Pub. No.: US 2002/0185023 A1
(43) Pub. Date: Dec. 12, 2002

(54) Printing unit with inker for varying-diameter plate cylinder

(76) Inventors: Charles Henry Dufour, Durham, NH (US); Charles Reif Hammond, Durham, NH (US); John Thomas Lorrey, Kittery Point, ME (US)

Correspondence Address: DAVIDSON, DAVIDSON & KAPPEL, LLC, 14th Floor, 485 Seventh Avenue, New York, NY, 10018, US

(21) Appl. No.: 09/876,600

(22) Filed: Jun. 7, 2001

(51) Int. Cl. B41F 7/02

(52) U.S. Cl. 101/218

(57) ABSTRACT

A printing unit includes a plate cylinder, a blanket cylinder for printing a first side of a web of material, and an inker with a plurality of inker rollers for inking the plate cylinder. The inker is movable between an active position and an inactive position, the inker contacting the plate cylinder in the active position and the inker being separated from the plate cylinder in the inactive position. At least one of the plurality of inker rollers is adjustable as a function of a diameter of the plate cylinder when the inker is in the inactive position.

### BACKGROUND OF THE INVENTION

The present invention relates generally to printing presses and more specifically to a printing unit with a plate cylinder which may vary in diameter.

U.S. Pat. No. 5,025,726 discloses a movable inker type printing machine in which an inker for a satellite printing press is automatically detachable to the press when in a clutch-off position, and automatically connects itself to the press when a clutch-on instruction is received. The plate cylinders of the printing press do not vary in diameter.

U.S. Pat. No. 5,640,906 discloses a short multi-color web-fed rotary printing press utilizing a vertical stack of bridge printing units which are supported by horizontally shiftable frame sections. Inking units move with their respective printing cylinders on a common frame. The printing cylinders are of a same diameter.

### BRIEF SUMMARY OF THE INVENTION

An object of the present invention is to provide a printing unit in which the plate cylinders of varying diameter can be easily inked.

The present invention thus provides a printing unit having a plate cylinder, a blanket cylinder for printing a first side of a web of material, and an inker with a plurality of inker rollers for inking the plate cylinder, the inker being movable between an active position and an inactive position, the inker contacting the plate cylinder in the active position and the inker being separated from the plate cylinder in the inactive position. At least one of the plurality of inker rollers is adjustable as a function of a diameter of the plate cylinder. Preferably this adjustment occurs as the inker is in the inactive position.

The print unit thus is operable even though the diameter of the plate cylinder varies. The plate cylinder may be automatically variable or may be variable by using a replacement plate cylinder with a different diameter.

“Plate cylinder” as defined herein includes any imaging unit, and may include plate cylinders with attachable flat or sleeve-shaped plates, and may also include directly imagable cylinders.

The inker with its plurality of inker rollers may be moved on a carriage in a manner similar to that disclosed in U.S. Pat. No. 5,025,726, which is hereby incorporated be reference herein. Preferably, at least two of the inker rollers are adjustable as a function of the plate cylinder diameter and directly contact the plate cylinder in the active position of the inker.

The plate cylinder and blanket cylinder preferably are mounted rotatably to a center frame section, and the inker is mounted to a first frame section movable with respect to the center frame section.

Preferably, the printing unit further includes a second plate cylinder, a second blanket cylinder for printing a second side of the web, and a second inker with a plurality of second inker rollers for inking the second plate cylinder, the second inker being movable between a second active position and a second inactive position, the second inker contacting the second plate cylinder in the second active position and the second inker being separated from the second plate cylinder in the second inactive position. At least one of the plurality of second inker rollers is adjustable to a diameter of the second plate cylinder when the second inker is in the second inactive position.

The plate cylinder, blanket cylinder, second plate cylinder and second blanket cylinder all may be supported rotatably on a center frame section, and the second inker may be supported on a second frame section movable with respect to the center frame section.

Preferably, at least one of the inker rollers contacts the plate cylinder when the inker is in the active position. At least one of the second inker rollers also preferably contacts the second plate cylinder when the second inker is in the active position.

The plate cylinders and the blanket cylinders may be exchangeable, so that a different diameter cylinder may be accommodated. The cylinders also may have an automatic diameter change, such as disclosed for example in commonly-owned U.S. Ser. No. 09/845,556 entitled “VARIABLE-DIAMETER CYLINDRICALLY-SHAPED BODY” filed Apr. 30, 2001, which is hereby incorporated by reference herein.

The plate cylinders may include at least one exchangeable plate shell for carrying a printing plate, and the blanket cylinders may include at least one exchangeable blanket shell for carrying a blanket. A plurality of shells may be aligned axially so that a wide-format web may be printed.

The blanket cylinders preferably include a removable blanket, which may be flat or tubular shaped.

A dampening unit for the plate cylinder may be connected to the center frame section, as may be a second dampening unit for the second plate cylinder may also be connected to the center frame. Alternately, the dampening units may be connected to the movable first or second frame sections and thus be considered to define part of the respective active position together with their respective inking units.

An overhead hoist may be provided to assist in the removal of cylinders, rollers or shells.

Preferably, the plate cylinder and the second plate cylinder are in a similar horizontal plane.

The plate cylinder and the blanket cylinder may be driven by a common drive motor or by two individual drive motors. Further, the blanket cylinder and the second blanket cylinder may be driven by a common drive motor and each of the plate cylinder and the second plate cylinder by an individual drive motor. The motors may be driven by one of the drive motors of the plate cylinders or the blanket cylinders. It is also possible to drive the inkers by at least one individual drive motor.

Preferably, a roll-away mechanism for the movable side frame, I.e. the first frame section and the second frame section, is provided, e.g. a motor-driven mechanism with a rail system supporting the movable sections. Moreover, a linear motor can be used to roll away the movable sections.

The blanket cylinder may act with the second blanket cylinder to print the web from both sides or may with an impression cylinder to print the web from only one side.

The present invention also provides a method for performing an operation on a plate cylinder comprising the steps of:

inking the plate cylinder with an inking unit at a first circumferential location of the plate cylinder;

moving the inking unit out of contact with the plate cylinder;

altering a diameter of the plate cylinder so as to define a new diameter; and

altering the inker to accommodate the new diameter.

Preferably, the altering of the inker includes moving at least one ink roller that contacts the plate cylinder.

### BRIEF DESCRIPTION OF THE DRAWINGS

The present invention is described below by reference to the following drawings, in which:

FIG. 1 shows a side view of a web printing press with printing units according to the present invention;

FIG. 2 shows a side view of a printing unit according to the present invention with the inking unit in the active position for a plate cylinder having a first diameter;

FIG. 3 shows a side view of the printing unit of FIG. 1 with a new diameter plate cylinder, and the inking units in an inactive position with an altered effective diameter to accommodate the new diameter; and

FIG. 4 shows a side view of the printing unit of FIG. 2 in the active position.

### DETAILED DESCRIPTION

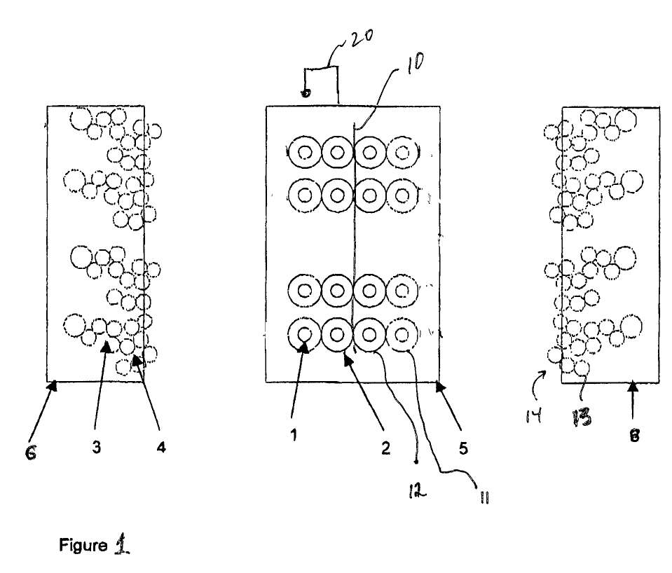

FIG. 1 shows a side view of a four print-unit web offset lithographic printing press, each print unit being a preferred embodiment according to the present invention. Each print unit has a first plate cylinder 1, which may include a plurality of axially-extending shells, each with a gap for at least one lithographic offset printing plate, although tubular plates or direct imaging are also possible. A first blanket cylinder 2 may have an axially-removable or flat blanket 42 attached thereto, or to similar axially extending shells. A similarly-constructed second blanket cylinder 12 forms a nip with first blanket cylinder 2, through which nip a web 10 passes. A second plate cylinder 11 is provided to image the second blanket cylinder 12.

Blanket cylinders 2, 12 and plate cylinders 1, 11 are supported rotatable in a central frame section 5. A hoist 20 may be provided to aid in removing one or more of the cylinders 1, 2, 11, 12.

Moveable with respect to central frame section 5 are a first frame section 6 and a second frame section 8, which support inking units 4 and 14 respectively. Inking unit 4 has ink rollers 3 and inks plate cylinder 1 when at least one, and preferably at least two, of rollers 3 contacts plate cylinder 1, which is accomplished by moving first frame section 6 toward central frame section 5 so that an active position of inking unit 4 is defined. Inking unit 14 has ink rollers 13 for similarly inking plate cylinder 11.

FIG. 1 shows the inking units 4, 14 in an inactive position. In this position, the plate cylinders 1, 11 may be altered so that their diameter changes, for example by replacing the plate cylinders 1, 11 with new cylinders using hoist 20, or automatically changing the diameter if the plate cylinders 1, 11 accommodate such an action. Further, shells may be exchanged by different diameter shells.

FIG. 2 shows the inkers 4 and 14 contacting their respective plate cylinders 1 and 11. Inker 4 contacts a lithographic printing plate located on an outer shell 41 of plate cylinder 1. The plate cylinder 1 to its outer surface has a radius r1, and a diameter equal to2* r1. In this exemplary embodiment, the inker 4 has three inker rollers 3a, 3b, 3c which contact the plate in the active position, and define an effective radius equal to r1. At least two of the rollers 3a, 3b, 3c are movable, for example by a motor, in at least one of the directions x, y shown. They also may be pivoted.

Dampening units 30, 32 may be provided for each plate cylinder 1, 11, and may be connected to the center frame section 5 (FIG. 1) or the movable side sections 6, 8.

In the position shown in FIG. 2, images on plate cylinders 1 and 11 are transferred, respectively, to blanket cylinders 2, 12 and then to opposing sides of web 10. The inkers 4 and 14 thus are in an active position, with all three inkers 3a, 3b, 3c contacting plate cylinder 1.

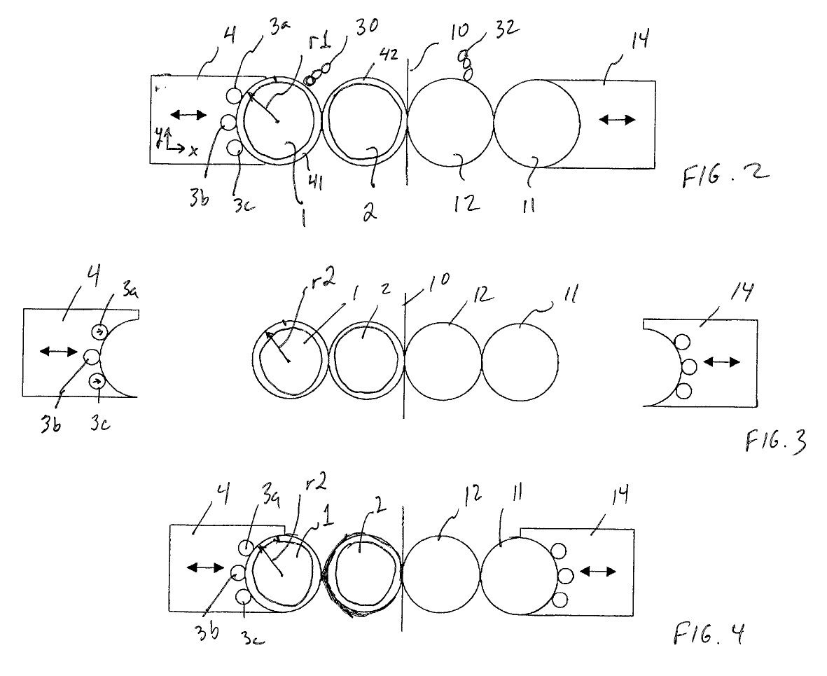

As shown in FIG. 3, the inkers 4, 14 may then be moved away from their respective plate cylinder 1, 11 to an inactive position. The cylinder 1 diameter may then be changed by cylinder or shell exchange or an automatic diameter change, so that cylinder 1 now has a radius r2 and a diameter equal to 2*r2. The diameter of blanket cylinder 2 may also be changed. The effective radius of the three ink rollers 3a, 3b, 3c may then be changed to match the radius r2, for example by translating rollers 3a, 3c in the x direction.

As shown in FIG. 4, the inkers 4, 14 may then be moved into thier active position, with all three rollers 3a, 3b, 3c contacting plate cylinder 1.

The plate cylinder is defined as any plate cylinder in the operative position of the print unit, so that a plate cylinder as defined herein may include either of two plate cylinders of different diameters.

The shells of the plate cylinder may also be exchangeable so as to alter the diameter of the plate cylinder.

What is claimed is:

1. A printing unit comprising:
a plate cylinder;
a blanket cylinder for printing a first side of a web of material; and
an inker with a plurality of inker rollers for inking the plate cylinder, the inker being movable between an active position and an inactive position, the inker contacting the plate cylinder in the active position and the inker being separated from the plate cylinder in the inactive position, at least one of the plurality of inker rollers being adjustable as a function of a diameter of the plate cylinder when the inker is in the inactive position.

2. The printing unit as recited in claim 1 wherein the blanket cylinder includes at least one blanket.

3. The printing unit as recited in claim 1 wherein the plate cylinder and blanket cylinder are mounted rotatably to a center frame section, and the inker rollers are mounted rotatably to a first frame section movable with respect to the center frame section.

4. The printing unit as recited in claim 1 further comprising a second plate cylinder, a second blanket cylinder for printing a second side of the web, and a second inker with a plurality of second inker rollers for inking the second plate cylinder, the second inker being movable between a second active position and a second inactive position, the second inker contacting the second plate cylinder in the second active position and the second inker being separated from the second plate cylinder in the second inactive position, at least one of the plurality of second inker rollers being adjustable to a diameter of the second plate cylinder when the second inker is in the second inactive position.

5. The printing unit as recited in claim 4 wherein the plate cylinder, blanket cylinder, second plate cylinder and second blanket cylinder are supported rotatably on a center frame section, and the second inker is supported on a second frame section movable with respect to the center frame section.

6. The printing unit as recited in claim 1 wherein at least one of the plurality of inker rollers contacts the plate cylinder when the inker is in the active position.

7. The printing unit as recited in claim 4 wherein at least one of the plurality of inker rollers contacts the plate cylinder when the inker is in the active position and at least one of the second inker rollers contacts the second plate cylinder when the second inker is in the second active position.

8. The printing unit as recited in claim 1 wherein the plate cylinder has a variable diameter.

9. The printing unit as recited in claim 1 wherein the plate cylinder is exchangeable.

10. The printing unit as recited in claim 1 wherein the plate cylinders includes at least one exchangeable plate shell for carrying a printing plate.

11. The printing unit as recited in claim 2 wherein the blanket is tubular shaped.

12. The printing unit as recited in claim 3 further comprising a dampening unit for the plate cylinder connected to one of the center frame section and the first frame section.

14. The printing unit as recited in claim 1 further comprising an overhead hoist to assist in removal of at least one of the plate cylinder, blanket cylinder and inker rollers.

15. The printing unit as recited in claim 1 wherein the plate cylinder and the blanket cylinder define a horizontal plane.

16. A method for performing an operation on a plate cylinder comprising the steps of:
inking the plate cylinder with an inking unit at a first circumferential location of the plate cylinder;
moving the inking unit out of contact with the plate cylinder;
altering a diameter of the plate cylinder so as to define a new diameter; and
altering the inker to accommodate the new diameter.

17. The method as recited in claim 16 wherein the altering of the inker includes moving at least one inker roller of the inking unit.

18. The method as recited in claim 16 wherein the altering of the inker includes moving at least two inkers roller of the inking unit 19. A vertically-stacked printing press comprising:
a first printing unit including a first plate cylinder, a first blanket cylinder for printing a first side of a web of material and a first inker with a plurality of first inker rollers for inking the first plate cylinder, the first inker being movable between a first active position and a first inactive position, the first inker contacting the first plate cylinder in the first active position and the first inker being separated from the first plate cylinder in the first inactive position, at least one of the plurality of first inker rollers being adjustable as a function of a diameter of the first plate cylinder when the first inker is in the first inactive position; and
a second print unit above the first printing unit, the second print unit including a second plate cylinder, a second blanket cylinder for printing the first side of the web, and a second inker with a plurality of second inker rollers for inking the second plate cylinder, the second inker being movable between a second active position and a second inactive position, the second inker contacting the second plate cylinder in the second active position and the second inker being separated from the second plate cylinder in the second inactive position, at least one of the plurality of second inker rollers being adjustable to a diameter of the second plate cylinder when the second inker is in the second inactive
